(19) United States
(12) Patent Application Publication
(10) Pub. No.: US 2024/0085533 A1
(43) Pub. Date: Mar. 14, 2024

(54) ILLUMINATION DEVICE, LIGHT DETECTION DEVICE AND METHOD

(71) Applicant: Sony Semiconductor Solutions Corporation, Kanagawa (JP)

(72) Inventors: Anthony ANTOUN, Stuttgart (DE); Ruxandra-Marina FLOREA, Stuttgart (DE); Victor BELOKONSKIY, Stuttgart (DE)

(73) Assignee: Sony Semiconductor Solutions Corporation, Kanagawa (JP)

(21) Appl. No.: 17/767,916

(22) PCT Filed: Oct. 20, 2020
(86) PCT No.: PCT/EP2020/079461

§ 371 Date: Apr. 11, 2022

(30) Foreign Application Priority Data
Oct. 24, 2019 (EP) 19205091.2

(51) Int. Cl. G01S 7/484; G01S 7/4911

(52) U.S. Cl. CPC G01S 7/484; G01S 7/4911

(57) ABSTRACT

An illumination device for a light detection device, the light detection device including a light detection sensor and an optical lens portion, wherein the illumination device includes a light source configured to emit light to a scene and a light intensity adapting device configured to adapt a light intensity profile of the light emitted by the light source for at least partially providing a uniform light intensity on the light detection sensor of light reflected from the scene and detected by the light detection sensor through the optical lens portion.

### TECHNICAL FIELD

The present disclosure generally pertains to an illumination device for a light detection device and a light detection device and a method for providing light detected by a light detection device.

### TECHNICAL BACKGROUND

Generally, light detection devices such as time-of-flight (ToF) devices, structured light scanners or stereo cameras or the like are known, which are used for determining a distance to or a depth map of a scene. Typically, a light detection device includes, e.g., an illumination device, optical parts, such as an optical lens portion including e.g. an optical lens and an optical filter, and an image sensor, etc.

Time-of-flight includes a variety of methods that measure the time that a particle or a light wave needs to travel a distance in a medium. Known ToF devices can obtain depth measurements of objects in a scene for every pixel of the depth image simultaneously, wherein the depth image is captured with an image sensor. For capturing this image, the ToF device typically illuminates the scene with, for instance, a modulated light wave and images the backscattered light wave with an optical lens portion on the image sensor having, for example, a pixel array, wherein a gain of the pixel array is modulated accordingly. Signal depth information can be obtained from the resulting modulation.

In optical systems having a wide field of view, e.g. cameras including optical lenses such as a fisheye lens or a ToF device including a wide angle lens to obtain a depth image of a larger scene, and, for example, when optimizing the illumination device in order to achieve near-uniform illumination on the scene it is known that the intensity of the light from the scene imaged onto an image sensor is typically lower at the corners and borders of the image, i.e. for larger angles. In situations with a high background brightness the proportion of transmitted modulated light corresponding to the scene, that hits the pixels of the image sensor, may decrease. This proportion can determine the signal-to-noise ratio (SNR) of the image sensor (i.e. light detection sensor), which can be taken as an indicator of the performance of a light detection device.

Although there exist techniques for a light detection device, it is generally desirable to improve an illumination device for a light detection device, a light detection device and a method for providing light detected by a light detection device.

### SUMMARY

According to a first aspect the disclosure provides an illumination device for a light detection device, the light detection device including a light detection sensor and an optical lens portion, wherein the illumination device comprises: a light source configured to emit light to a scene; and a light intensity adapting device configured to adapt a light intensity profile of the light emitted by the light source for at least partially providing a uniform light intensity on the light detection sensor of light reflected from the scene and detected by the light detection sensor through the optical lens portion.

According to a second aspect the disclosure provides a light detection device, comprising: a light detection sensor configured to detect light; an optical lens portion configured to image light reflected from a scene onto the light detection sensor; a control configured to acquire images from the detected light; and an illumination device for the light detection device, wherein the illumination device includes a light source configured to emit light to the scene; and a light intensity adapting device configured to adapt a light intensity profile of the light emitted by the light source for at least partially providing a uniform light intensity on the light detection sensor of light reflected from the scene and detected by the light detection sensor through the optical lens portion.

According to a third aspect the disclosure provides a method for providing light detected by a light detection device, the light detection device including a light detection sensor and an optical lens portion, the method comprising: emitting light to a scene; and adapting a light intensity profile of the light emitted by the light source for at least partially providing a uniform light intensity on the light detection sensor of light reflected from the scene and detected by the light detection sensor through the optical lens portion.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates an embodiment of a light detection device as a time-of-flight device;

FIG. 2 illustrates a principle functionality of a time-of-flight device;

FIG. 3 illustrates an embodiment of an illumination device for a light detection device such as a time-of-flight device;

FIG. 4 illustrates a principle of a calculation method of a field of view of an optical lens portion on a predetermined virtual target area;

FIG. 5 shows a flowchart of an embodiment of a method for providing light detected by a light detection device; and

FIG. 6 shows a flowchart of an embodiment of a method for calculating a light intensity profile for a light detection device.

### DETAILED DESCRIPTION OF EMBODIMENTS

Before a detailed description of the embodiments under reference of FIG. 1 is given, general explanations are made.

As mentioned in the outset, it has been recognized that it may be generally desirable to improve the performance of a light detection device and an indicator of the performance of a light detection device is the SNR of the light detection sensor.

For instance, in the automotive context more and more interior sensing capabilities are required to monitor the interior of a cabin for increasing the security; for example, in autonomous driving scenarios where the vehicle computer needs to check whether it is safe to pass the control of the vehicle back to the driver. It has been recognized that, for example, ToF devices are able to perform interior sensing with a wide field of view. Ideally, a single ToF device could allow for the monitoring of the driver and passengers in the vehicle, and to perform general activity recognition in the cabin of e.g. a car, while reducing the number of cameras required to perform a full monitoring of the interior of the car cabin which reduces costs and power consumption inside the car.

Generally, the field of view of an optical lens portion corresponds to the part of a scene, which is effectively detected by a light detection sensor in a light detection device and, as further discussed below, it is connected to the image of the light detection sensor as distorted by the optical lens portion.

However, as mentioned in the outset, the use of a wide field of view lens, for example an optical lens portion in a ToF device, may typically decrease the amount of light reflected from a scene (e.g. the driver and front passengers in the car cabin), which hits the pixels of the light detection sensor at the corners and borders of the image. Thus, in situations with high background brightness, e.g. day light in the car cabin, the SNR typically decreases at the borders of the image. Other cases of interior sensing with high ambient light conditions, i.e. background brightness, may be in drones flown in closed compounds or in planes in commercial flights for passenger monitoring or the like.

The lower SNR in these image regions may come from natural vignetting and intrinsic relative illumination loss inside the optical lens portion of the ToF device towards the borders. In optical systems the natural vignetting may be a natural illumination falloff due to the larger angle at which the light impinges on the light detection sensor and, thus, it is especially a loss channel in wide field of view optical systems.

It has been recognized, when using, for example, one ToF device for interior sensing of the whole cabin in a car, that the driver's head and the steering wheel lie at the borders of the field of view, i.e. from the image. The failure rate, for example, in such autonomous driving scenarios and activity recognition may have to be very small and, thus, it is has been recognized that it is desirable that the SNR in the ToF device is uniform in all regions of the image sensor to increase the performance of the ToF device.

An illumination device of the ToF device could increase the light intensity with which the scene is illuminated to increase the amount of reflected light, however, it has been further recognized that this might increase the power consumption in the vehicle and might lead to a sensor saturation in other parts of the image.

Moreover, the intrinsic image distortion of wide field of view lenses, i.e. lens distortion, may not be neglected on the illumination side of the ToF in some instances, since any illuminated light falling outside the field of view of the optical lens portion can add up to the total power losses.

Furthermore, it has been recognized that in situations such as wide field of view car cockpit monitoring the object plane (or object area, which is imaged onto the light detection sensor) may be approximated by a spherical area (or an application specific area) rather than a planar area, which may be illuminated in an optimized way such that the light intensity on the light detection sensor is at least partially uniform. This is because a planar area may not be enough to cover the entire wide field of view, i.e. approaching 180°, since marginal rays, i.e. rays making an angle approaching 900 with the optical axis, are almost parallel with the planar area and, hence, may never reach it. Consequently, the pixels in a light detection sensor corresponding to where such marginal rays originate may receive no information.

Hence, it has been recognized that improving the illumination side, i.e. the illumination device, of a light detection device can improve the overall system performance of the light detection device in some embodiments.

Consequently, some embodiments pertain to an illumination device for a light detection device, the light detection device including a light detection sensor and an optical lens portion, wherein the illumination device includes a light source configured to emit light to a scene and a light intensity adapting device configured to adapt a light intensity profile of the light emitted by the light source for at least partially providing a uniform light intensity on the light detection sensor of light reflected from the scene and detected by the light detection sensor through the optical lens portion.

The illumination device may be an illumination device for illuminating a scene or a region of interest from which light may be reflected. The illumination device is for a light detection device (e.g. ToF device, structured light scanner or stereo cameras or the like) such that the reflected light, which was emitted by the illumination device, may be detected by the light detection device to obtain depth information about the illuminated scene.

Generally, a ToF device may be a direct ToF (dToF) device, wherein a distance is determined based on a run-time of an emitted (and reflected) light signal, which may be a pulsed light signal, or an indirect ToF (iToF) device, wherein a distance is determined based on a phase shift of a reflected light relative to the a sensing signal without limiting the present disclosure to exemplary embodiments of a ToF device (other embodiments may be based, for example, on gated ToF or any other known ToF technology). In the case of iToF, a modulated light is emitted from the illumination device of the ToF device to the scene. The scene reflects or scatters the modulated light and the reflected/scatter modulated light is imaged onto a light detection sensor by an optical lens portion of the ToF device and the detected light signal is demodulated. Thereby, a phase shift of the emitted modulated signal and the detected demodulated signal can be determined, which is indicative of the distance between the ToF device and the scene. The ToF device may compute a 3D depth information of the scene based on the acquired images.

For the detection of the reflected light in the light detection device, the light detection sensor may include a plurality of light detection pixels. The light detection pixels may be arranged as an array or in any regular pattern. The light detection sensor may be a charge coupled device (CCD), an active pixel sensor, based on CMOS technology, or the like, may include one or more SPADs (single-photon avalanche diodes), CAPDs (current assisted photonic demodulator), etc. The light detection pixels may be based on inorganic and/or organic photoconversion elements, i.e. photodetectors, such as semiconductor or organic photodiodes or -transistors or the like, avalanche photodiodes, photomultipliers, thermopiles etc. such that the reflected illumination light is detected.

Moreover, the light detection sensor may detect near infrared or infrared light. Additionally, the light detection sensor may include a color filter or each of the light detection pixels may include a color filter, wherein the color filters may filter different spectral regions. Each pixel may be covered by a microlens. Furthermore, the array may be a quadratic or rectangular or of any other two-dimensional pattern of individual light detection pixels, wherein each of the light detection pixels may be read out by a control.

The optical lens portion images the reflected light from the scene, which is in the field of view of the optical lens portion, onto the light detection sensor. The optical lens portion may include optical lenses, irises, optical filter, polarization dependent optical elements such as birefringent materials or the like, etc. It may include a wide field of view lens such as a fisheye lens or the like. It may be a single optical lens or an optical lens stack or the like. The optical lens portion may be arranged above the light detection sensor. The optical lens portion may be defined already at the construction stage of the illumination device.

In the illumination device a light source is included which emits light to the scene. The light source may be a, light emitting diode (LED) based on inorganic or organic semiconductors or a laser device, or the like. For example, the LEDs may emit near infrared or infrared radiation, however, the light source is not limited to this. The laser device may be a laser diode or a vertical cavity surface emitting laser (VCSEL) or the like, wherein the light emission profile may be controlled by an electric signal. Furthermore, the light source may include a plurality of LEDs or VSCEL arranged in an array or any regular or irregular pattern. The light source may emit continuous light or pulsed light and/or may emit light having a predetermined modulation.

The light source may be controllable by an electric (control) signal (e.g. electrical voltage or current or the like). In such embodiments, the control of the light source by an electric signal controls a light emission profile of the light source.

Moreover, the light source may emit different wavelengths, i.e. spectral regions, in different spatial directions or all of the emitted wavelengths are superimposed in the light intensity profile.

Here, the scene may be a region to be monitored by the light detection device, which may include objects and/or persons of interest such as passengers in a car or plane cabin or the like, which reflect the light emitted by the illumination device and which is detected by the light detection sensor of the light detection device.

The light intensity adapting device adapts a light intensity profile of light emitted by the light source for at least partially providing a uniform light intensity on the light detection sensor of light reflected from the scene and detected by the light detection sensor through the optical lens portion.

The light intensity profile may be characterized by its size and shape, i.e. illumination pattern or region of interest or field of illumination, and by its light intensity distribution. Both may be adapted by the light intensity adapting device and, thus, it may include optical elements such as optical lenses, diffractive optical elements (DOE), or the like for that purpose.

Consequently, the scene may be illuminated non-uniformly, but the light detection sensor is illuminated uniformly by the reflected light. For example, the light intensity distribution may be such that the border regions of the scene are illuminated with a higher light intensity than the center part. Furthermore, the illumination pattern may be adapted to the field of view of the optical lens portion, which corresponds to the image of the light detection sensor as distorted by the optical lens portion (i.e. inverted distortion of the optical lens portion). In such embodiments, the light reflected from the scene provides at least partially a uniform light intensity on the light detection sensor after passing the optical lens portion.

In general, adapting the light intensity profile for providing at least partially a uniform light intensity on the light detection sensor, improves the performance of the light detection device on the following points in some embodiments:
sunlight robustness, i.e. increased SNR in situations with high background brightness, by maximizing the active light intensity on the light detection sensor, especially on the usually darker areas (i.e. wide field angles of the lens);
minimize heat dissipation within the light detection sensor with an equal performance (i.e. SNR); and
facilitate the processing chain by reducing the illumination gradient on the image.

Moreover, all light is concentrated on the light detection sensor to have a uniform SNR on the entire image in some embodiments and, thus, the overall emitted light intensity can be decreased leading to a reduced power consumption.

In some embodiments, the adaption of the light intensity profile is based on a relative illumination loss of the optical lens portion.

Here, the relative illumination loss of the optical lens portion corresponds to the combined loss due to (i) natural vignetting and (ii) intrinsic relative illumination loss in the optical lens portion, as discussed above. The relative illumination loss may determine the intensity distribution of the adapted light intensity profile.

The relative illumination loss of the optical lens portion may lead to a lower intensity of light reflected from a scene at the border regions on the light detection sensor.

Hence, the light intensity distribution of the adapted light intensity profile may be such that the light intensity is higher at the border regions of the illuminated scene to compensate the relative loss of the optical lens portion at the border regions of the scene. In such embodiments, the light intensity profile is adapted accordingly such that at least partially a uniform light intensity is provided on the light detection sensor.

Thus, the adaption of the light intensity profile is based on a relative illumination loss of the optical lens portion.

In some embodiments, the adaption of the light intensity profile is further based on a distance between the light detection sensor and a predetermined virtual target area.

For the adaption of the light intensity profile, a predetermined virtual target area is defined. The predetermined virtual target area is not a real physical area, but it is a virtual area in space representing a typical size and shape of the illuminated scene in which, for example, objects or persons are typically present such as a driver on a driver seat inside a car cabin. The predetermined virtual target surface may be defined already at the construction stage of the illumination device.

As mentioned above, the illumination device illuminates the scene, which generally is not known, since, for example, the objects and passengers present in the scene change their position. The predetermined virtual target area may represent a typical area on which most of the objects and passengers are present from which the light of the illumination device, i.e. the light intensity profile, is reflected and detected by the light detection sensor. In such embodiments, at least partially a uniform light intensity is provided on the light detection sensor.

The predetermined virtual target area is virtually defined in space at a distance from the light detection sensor and, in general, the intensity of light reflected from the objects decreases with the inverse square of the distance from the objects. Since the objects may be present or move on or in the vicinity of the predetermined virtual target area, the distance between the light detection sensor and the predetermined virtual target area is relevant to the adaption of the light intensity profile.

Therefore, the adaption of the light intensity profile is further based on the distance between the light detection sensor and the predetermined virtual target area.

The distance between the light detection sensor and the predetermined virtual target area may determine (or define) how large the area of illumination, i.e. illumination pattern of the light intensity profile, is and, thus, the light intensity profile may be adapted accordingly.

Moreover, the overall light intensity of the light intensity profile may be adapted based on the distance between the light detection sensor and the predetermined virtual target area such that the reflected light intensity on the light detection sensor is above a detection threshold.

In some embodiments, the adaption of the light intensity profile is further based on a shape of the predetermined virtual target area.

In general, the predetermined virtual target area may be any kind of area, which covers the field of view of the optical lens portion. It may be a planar area, a ring area, a circle area, a spherical area (i.e. a part of a surface of a sphere), a paraboloid or the like.

Depending on the scenario or scene to be monitored by the light detection device, the predetermined virtual target area may be chosen accordingly. For example, a spherical area may represent a car interior better than a planar area, since it covers the whole field of view of, for example, a wide-angle lens used in car interior sensing scenarios.

In such embodiments, a radius of the spherical area may be chosen such that the front seats are on the spherical area and the light intensity profile may have an intensity distribution, which has a higher intensity at the borders of the spherical area to have a higher intensity at the front seats.

Consequently, the light intensity profile may be adapted on the shape of the predetermined virtual target area.

In some embodiments, the adaption of the light intensity profile is further based on a field of view of the optical lens portion projected on the predetermined virtual target area.

As mentioned above, the field of view of the optical lens portion is the region of interest in a scene, which is effectively detected by the light detection sensor.

For illustration, assuming the light detection sensor is or includes, for example, an array of light detection pixels, any light ray reaching the light detection sensor may be captured by any pixel. The light rays may be refracted by the optical lens portion and enter at a certain angle at an output surface of the optical lens portion.

Herein, an input surface of the optical lens portion is the surface which is oriented towards the light detection sector and an output surface of the optical lens portion is the surface which is oriented towards the scene. Thus, the light reflected from the scene enters the optical lens portion at the output surface and leaves the optical lens portion at the input surface.

Generally, light rays and projection vectors (projection rays) are distinguished herein: A light ray following the classic optics definitions is emitted by a light source that is either active (which is part of the illumination device of the light detection) or ambient (such as, but not restricted to, sunlight), and may scatter off a scene object before traveling through the optical lens portion, from the output surface to the input surface, and is finally detected by a pixel on the light detection sensor.

A projection vector, i.e. projection ray, as referred to in this application, is a mathematical approximation of a light ray or a bundle of light rays, and has an opposite direction to the light ray or the bundle of light rays it approximates, and has the properties of an Euclidean vector in three dimensions. A projection vector has its origin in the coordinates of the pixel, which detected the light ray or which detected the bundle of light rays approximated by the projection vector.

Moreover, the projection vector is oriented towards a specific point on the scene which approximates the point, or the points, at which the light ray or the bundle of light rays, approximated by the projection vector, has scattered off. A light detection device may use such projection vectors to reconstruct a 3D model of the scene based on the information captured by the light detection sensor.

For example, a simulation software may trace light rays from the scene through the optical lens portion to the light detection sensor. Based on the result of this simulation, a projection vector is computed for each pixel of the light detection sensor, which approximates all light rays that hit that pixel.

The intersection of the projection vectors with the predetermined virtual target area may correspond to the field of view, i.e. the region of interest, of the optical lens portion (i.e. the field of view of the optical lens portion is projected onto the predetermined virtual target area).

In other words, the image of the light detection sensor as distorted by the optical lens portion may determine the field of view (inverted distortion of the optical lens portion).

For example, the predetermined virtual target area may be a spherical area, wherein the center point of the corresponding sphere coincides with the light detection sensor. This is, for example, advantageous in embodiments where a wide field of view lens is included in the optical lens portion, as it represents the object plane which is imaged onto the light detection sensor more realistically. In such embodiments, the field of view, i.e. region of interest, may be of pincushion shape and the illumination pattern of the light intensity profile may have a similar size and shape.

Hence, in some embodiments, the light intensity profile or the illumination pattern of the light intensity profile, as discussed above, is adapted based on the field of view of the optical lens portion projected on the predetermined virtual target area.

In general, in some embodiments, the combination of light source and light adapting device achieves the adaption of the light intensity profile by taking the following points into consideration at the construction stage of the illumination device: (i) the wide field of view of the optical lens portion (i.e. obtained with the inverted distortion of the optical lens portion) which is effectively detected by the light detection sensor, (ii) the natural vignetting and the intrinsic relative illumination loss in the optical lens portion (relative illumination loss), (iii) a predetermined virtual target surface, for example, a spherical area representing the shape of the scene (e.g. car cockpit), and (iv) the distance of the predetermined virtual target area from the light detection sensor.

Thereby, at least partially a uniform light intensity on the light detection sensor of light reflected from the scene and detected by the light detection sensor through the optical lens portion is provided in some embodiments.

In contrast, current illumination techniques either focus on the uniformity of the illumination on a planar area (planar uniformity) which is suboptimal with wide field of view lenses, or do not take the distortion of the optical lens portion and the relative illumination loss into account when defining the light intensity profile.

In some embodiments, the predetermined virtual target area is a curved area.

As discussed above, a curved area such as a spherical area, a paraboloid or the like is advantageous, since on the one hand it may represent the object plane which is imaged onto the light detection sensor more realistic than a planar area and on the other hand it may be better suited for a typical application scenario or scene to be monitored by the light detection device.

In some embodiments, the light intensity adapting device includes a diffractive optical element configured to adapt the light intensity profile based on the relative illumination loss of the optical lens portion.

Generally, a DOE can shape a light intensity profile and modulate its intensity distribution by diffraction at an optical lattice and constructive and destructive interference of partial beams.

The DOE may include a micro-structured surface relief providing the optical lattice or it may include a plurality of materials having different refractive index, which may be stacked or mixed or arranged in a specific structure or the like. The relative illumination loss of the optical lens portion decreases the light intensity on the light detection sensor in some parts of the image, typically at the border regions of the image, and, thus, the light intensity distribution of the light intensity profile may be adapted accordingly.

Hence, the DOE may be designed to achieve the adaption of the intensity distribution of the light intensity profile such that at least partially a uniform light intensity on the light detection sensor of light reflected from the scene and detected by the light detection sensor through the optical lens portion is provided.

Moreover, the DOE may include a glass substrate, wherein the micro-structured surface relief may be present on one or on both surfaces and the glass substrate may be curved or the like.

Furthermore, the adaption of the light intensity distribution may be achieved in combination with the light source and/or other optical elements included in the illumination device. The light source, i.e. the light emitted by the light source, may be controllable by an electric signal for providing different light emission profiles. In some embodiments, the light source may be an electrically controllable light source (i.e. projector).

In some embodiments, the light intensity adapting device further includes a field of illumination adapting lens configured to adapt the light intensity profile based on the field of view of the optical lens portion projected onto the predetermined virtual target area.

The field of illumination adapting lens may be any type of optical lens or lens stack or the like, for example, a wide field of view lens such as a fisheye lens or the like. It may include an iris or structured areas where it is not transparent such that shape and size of the illumination pattern of the light intensity profile is adapted according to the field of view of the optical lens portion projected onto the light detection sensor.

Furthermore, the adaption of the illumination pattern may be achieved in combination with the light source, the DOE and/or other optical elements included in the illumination device.

In some embodiments, the light intensity adapting device further includes a collimating lens configured to bundle the light emitted by the light source.

The light emitted by the light source may be divergent and the collimating lens may provide a parallel light beam or a low divergent beam, wherein the collimating lens may be arranged above the light source. The field of illumination adapting lens may be any type of optical lens or lens stack or the like.

The arrangement of the DOE, the field of illumination adapting lens, the collimating lens and/or other optical elements may not be limited to a specific stacking sequence or the like, as long as the light intensity profile is adapted as discussed.

In general, it may be overlooked that the amount of light lost by the lens distortion and by having an image circle illuminating a rectangle is not negligible. In this respect, lens and illumination DOE co-design is preferred in some embodiments and can lead to further increase in performance of light detection devices.

The construction of a special, wide field of illumination, i.e. illumination pattern, the light intensity adapting device may include a DOE on top of a VCSEL in order to:
invert the distortion of the optical lens portion (i.e. characterize the distortion of the optical lens portion while not performing distortion correction); and
compensate for the relative illumination loss inside the optical lens portion.

Thus, it may be accounted for the distortion of the optical lens at the construction, adjustment and configuration stage of the light emission profile of the VCSEL array.

As mentioned, due to the distortion of the optical lens portion, the light detection sensor's rectangular area corresponds to a certain region of interest on the sphere. This region of interest, i.e. field of view, may be of pincushion shape in an embodiment where the predetermined virtual target area is, for example, a spherical area.

The shape and size of the region of interest depends on the parameters of the optical lens portion and may be computed in a simulation environment based on a design file of the optical lens portion and the predetermined virtual target area. The simulation environment may include a lens design software, optical ray tracing functions and the like. This may be used advantageously in a construction stage of the optical lens portion (lens design, natural vignetting and intrinsic relative illumination loss in wield field of view lenses, etc.) and the illumination device (light emission profile, DOE, field of illumination adapting lens, etc.). The region of interest may be used as input when configuring the light intensity profile of the illumination device. For instance, the DOE (possibly also other elements in the illumination device such as the VCSEL) will be designed in such a way that the light intensity profile is adapted for providing at least partially a uniform light intensity on the light detection sensor of light reflected from the scene and detected by the light detection sensor through the optical lens portion.

In some embodiments, the diffractive optical element includes a micro-structured surface relief profile.

As mentioned, the micro-structured surface relief may be present on one or both surfaces of a glass substrate. The micro-structured surface relief may be a regular pattern of height differences on the surface like channels, edges, dots or the like.

In some embodiments, the light emitted by the light source is controllable by an electric signal, as discussed above.

The light source may be a laser diode, a single VCSEL or a VCSEL array, wherein the emitted light intensity may be controlled by an electric signal, e.g. an electrical voltage or electrical current, as discussed above. Furthermore, in the case of an array of VCSELs the electric signal may be applied at individual VCSEL in the array. In such embodiments, the light emission profile is controllable by the electric signal.

Furthermore, the electric signal may be a continuous signal, a pulsed signal or continuously modulated signal for providing the ToF functionality.

Hence, in some embodiments, the light source includes a vertical cavity surface emitting laser, as discussed above, which may emit near infrared light.

Some embodiments pertain to a light detection device, including a light detection sensor, an optical lens portion, a control configured to acquire images from the detected light, and an illumination device for the light detection device.

The light detection sensor, the optical lens portion and the illumination device are already discussed in detail above.

The control may include electronic circuitry such as a microprocessor (CPU) and memory and/or a field programmable gate array (FPGA) and the like to achieve the functions as described herein and of course, in particular, the synchronization, timing, signal modulation, computation of depth information and the like of the light detection device, in particular a ToF device. The electronic circuitry may include electronic components for implementing the functions as described herein. The control may include a communication interface (wired and/or wireless) to an external computer, e.g. a board computer in a vehicle or a server outside the vehicle, for receiving and transmitting data and/or commands.

In particular, the control acquires the images from the detected light from the light detection sensor, i.e. the generated electric signal (e.g. electrical charge carriers/voltage/current) is read out by the control via a connection line and may be stored in the memory or processed in the microprocessor. The light detection device may compute a 3D depth information of the scene based on the acquired images.

In some embodiments, the control is further configured to pre-process the acquired images.

The acquired images may be pre-processed directly in the control, since, due to the uniform light intensity on the light detection sensor, the image gradient is lower and the resources required for image processing are less. This pre-processing facilitates the image processing chain.

In some embodiments, the control is further configured to control the light source by an electric signal.

As mentioned-above, the light source may be controlled by an electric signal and, thus, the light emission profile of the light source may be controlled and, for example, a VCSEL array may be controlled to switch on and off individual VCSELs in the array or the light emission intensity may be increased or decreased by, for example, an electrical current. Therefore, the control may be connected to the light source via a connection line.

In some embodiments, the optical lens portion includes a wide field of view lens.

As discussed, the wide field of view lens may be an optical lens or an optical lens stack, which may be able to image a large part of the surrounding or the entire surrounding effectively on the light detection sensor, e.g. light rays approaching an angle of incidence to the optical axis of the lens of about 900 or more.

Hence, in some embodiments, the wide field of view lens includes a fisheye lens, as discussed.

As mentioned above, in some embodiments, the light detection sensor includes a plurality of light detection pixels.

Some embodiments pertain to a method for providing light detected by a light detection device, the light detection device including a light detection sensor and an optical lens portion, wherein the method includes a step of emitting light to a scene and of adapting a light intensity profile of the emitted light for at least partially providing a uniform light intensity on the light detection sensor of light reflected from the scene and detected by the light detection sensor through the optical lens portion, as discussed above.

Some embodiments pertain to a method for calculating a light intensity profile for a light detection device.

The steps required to define the light intensity profile of the illumination device are also described below.

The method includes, in some embodiments, defining a construction of the optical lens portion and the light detection sensor. As discussed above, the desired light intensity profile takes into account the parameters of the optical lens portion such as image distortion, field of view, natural vignetting and intrinsic relative illumination loss. Therefore, the optical lens portion for the light detection device, in particular a ToF device, in combination with the specific light detection sensor (e.g. size and number pixels or the like) needs to be defined for the calculation in some embodiments.

The method further includes defining light rays oriented towards the light detection sensor, and the light rays propagating towards an output surface of the optical lens portion.

The method further includes defining a predetermined virtual target area. As discussed above, the predetermined virtual target area may represent the typical shape of the illuminated scene and the predetermined virtual target area constitutes together with the distortion of the optical lens portion the illumination pattern of the light intensity profile.

The method further includes tracing of the light rays through the optical lens portion from the output surface to an input surface.

The method further includes, obtaining a relative illumination loss of the optical lens portion from the tracing of the light rays.

The method further includes obtaining projection vectors of the traced light rays at the output surface of the optical lens portion.

The method further includes obtaining a field of view of the optical lens portion on the predetermined virtual target area by the intersection of the projection vectors with the predetermined virtual target area corresponding to an image of the light detection sensor as distorted by the optical lens portion.

Thus, in some embodiments a step in the calculation of the light intensity profile is to invert the distortion of the light detection sensor's, e.g. a plurality of light detection pixels arranged in an array, effective area through the optical lens portion, which includes obtaining of projection vectors at the lens output surface.

To compute the projection of the light detection sensor to the predetermined virtual target area, projection vectors, or projection rays, are computed, wherein the projection vectors provide an approximation to light rays, which have been traced inside the optical lens portion and which go to the light detection sensor at directions, wherein the directions are defined by the physical elements of the optical lens portion and are affected by the lens distortion. As mentioned-above, the direction of the projection vectors is inverse to that of the light rays. The orientations of these projection vectors are lens-specific, i.e. any other optical lens portion will impose different orientations to the projection vectors. The intersection between the projection vectors and the predetermined virtual target area constitutes the image of the sensor as distorted by the optical lens portion.

Here, it is accounted for the distortion of the optical lens portion by relying on these projection vectors. It is noted that the method does not require the distortion to be corrected, nor does it aim to correct the distortion in the image. Thus, the method may not fall in the category of undistortion methods (as they are typically referred to in scientific literature).

For example, the pixel array may be projected against a surface that is representative of many car interiors (to avoid overfitting on particular car models), while still achieving sufficient performance levels in all cars. It is noted that the typical approach when evaluating (non-tailored) light intensity profiles is to employ a planar surface placed perpendicular to the lens' optical axis. However, a planar surface may not be enough to cover the entire field of view of wide-angle lenses, i.e. lenses with a field of view approaching 180°. That is because marginal rays, i.e. rays making an angle approaching 90° with the optical axis, may be parallel with the planar surface and, hence, may never reach it. Consequently, the pixels corresponding to such marginal rays may receive no information. On the other hand, for instance, a sphere whose centre coincides with the centre (optical centre) of the light detection sensor will cover the entire field of view of the optical lens portion.

In such embodiments, the radius of this sphere is decided according to the scene distance that is of interest. That is, in a car interior scenario, the front car seats would require a sphere with a smaller radius than the back seats. The radius of the sphere may, hence, be an input parameter of the method.

The method further includes calculating the light intensity profile based on the relative illumination loss, a distance between the light detection sensor and the predetermined virtual target area and the field of view.

The illumination pattern of the light intensity profile corresponds to the inverted distortion pattern of the optical lens portion on the predetermined virtual target area of dimensions that best represent, for example, the car interiors.

Hence, as discussed above, calculating the light intensity profile of the illumination device may be performed by considering: (i) the intrinsic relative illumination loss of the optical lens portion, (ii) vignetting due to the projection of an area element of the predetermined virtual target area on a plane, and (iii) the inverse-square law. This will result in at least partially uniform light intensity on the light detection sensor.

It is noted that in some embodiments the method does not require the light detection device to be available, since the distortion of the optical lens portion and the light detection sensor are known at the design stage.

As mentioned above, the adaption of the light intensity profile, according to the devices and methods as described herein may provide, for example:
maximization of the performance of the ToF device on all field points, hence improving sunlight robustness;
decreasing illumination power, hence minimizing heat dissipation and power consumption;
minimizing the confidence gradient, hence facilitating the processing chain; and
enabling the use of a single, wide field of view light detection device, in particular a ToF device, in the recording on the car interior, hence reducing the associated cost of sensors inside the car.

The methods as described herein are also implemented in some embodiments as a computer program causing a computer and/or a processor and/or circuitry to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is shown an embodiment of a light detection device as a time-of-flight device 1.

In the embodiment illustrated in FIG. 1, the ToF device 1 is used for interior sensing of a car cabin and configured as an iToF device. The activity of driver and passenger (not shown) on the two seats is monitored (a scene) by the ToF device 1 which acquires images of the car cabin to obtain spatially resolved depth information of the scene. In FIG. 1 the dimensions, angles and the like are not necessarily true to scale, since it is only provided for illustration purposes.

The ToF device 1 includes an illumination device 2 which has a light source 3 and a light intensity adapting device 4 arranged above the light source 3, wherein the light source 3 is includes a plurality of VCSELs arranged as an array (VCSEL array) emitting near infrared light to the scene.

From the light source 3 the light propagates through the light intensity adapting device 4 towards the scene and a predetermined virtual target area 5 is defined in space. Here, the predetermined virtual target area 5 is a spherical area. As mentioned above, in this embodiment, the spherical area better represents on the hand the car interior or the scene as a planar area and on the other hand it is better suited for wide field of view interior sensing applications.

The adapted light intensity profile 6 illuminates the scene and when reflected from the passengers and/or objects on predetermined virtual target area 5 the light reaches an optical lens portion 7 which images the light onto a light detection sensor 8. Here, the light detection sensor 8 is configured as a CAPD pixel array of rectangular shape consisting of a plurality of light detection pixels which detect near infrared light.

A control 9 is in included in the ToF device 1, which is connected to the illumination device 2 and the light detection sensor 8. As mentioned, the control 9 includes the necessary electronic components and processing capabilities to achieve the functions described herein. The control 9 has several functions: (i) provide the ToF functionality such as timing, synchronization, signal modulation and the like; (ii) acquire the images from the light detected with the light detection sensor; and (iii) compute depth information from the acquired images.

In this embodiment, the optical lens portion 7 distorts the image of the light detection sensor 8 from the rectangular image of the CAPD pixel array to a pincushion shaped image 10 on the predetermined virtual target area 5, i.e. spherical area. This defines the field of view in a distance from the light detection sensor 8. Since the light detection sensor 8 effectively detects this region of the scene, the illumination pattern of the light intensity profile 6 is based on the predetermined virtual target area 5 and the field of view of the optical lens portion 7.

The distance between the light detection sensor 8 and the predetermined virtual target area, i.e. here radius of the spherical area, determines the overall intensity the illumination device 2 has to provide to the scene, since the intensity of the reflected light decreases with the inverse square of the distance away from the source.

As can be seen, the intensity distribution of the light intensity profile 6 is not homogeneous (darker regions correspond to higher light intensity and vice versa) in order to compensate the relative illumination loss of the optical lens portion 7. The center of the light intensity profile 6 has a lower intensity than the border regions. This is advantageous as the middle of the seats, where the driver and the passenger are present, are in the border region of the spherical area and, thus, the regions of activity to be monitored are illuminated with more light compared to regions with no activity. This reduces the power consumption of the ToF device, since the light is used more effectively.

As discussed above, assuming, all light of the light intensity profile 6 is reflected from passengers and objects in the scene on the predetermined virtual target area 5, then the light intensity on the light detection sensor 8 is at least partially uniform. This is, because the light intensity profile 6 is adapted based on the distance between the light detection sensor 8 and the predetermined virtual target area, the predetermined virtual target area 5 and the field of view of the optical lens portion 7, corresponding to the inverted distortion of the optical lens portion 7, and the relative illumination loss of the optical lens portion 7.

Thereby, the SNR is the same in all regions of the image, in particular, at the border of the image. Thus, the border regions are monitored with the same or better sensitivity as the center region of the image, so that only one ToF device is needed to monitor the whole scene, which reduces costs. Additionally, the system is more robust in situations with high background brightness.

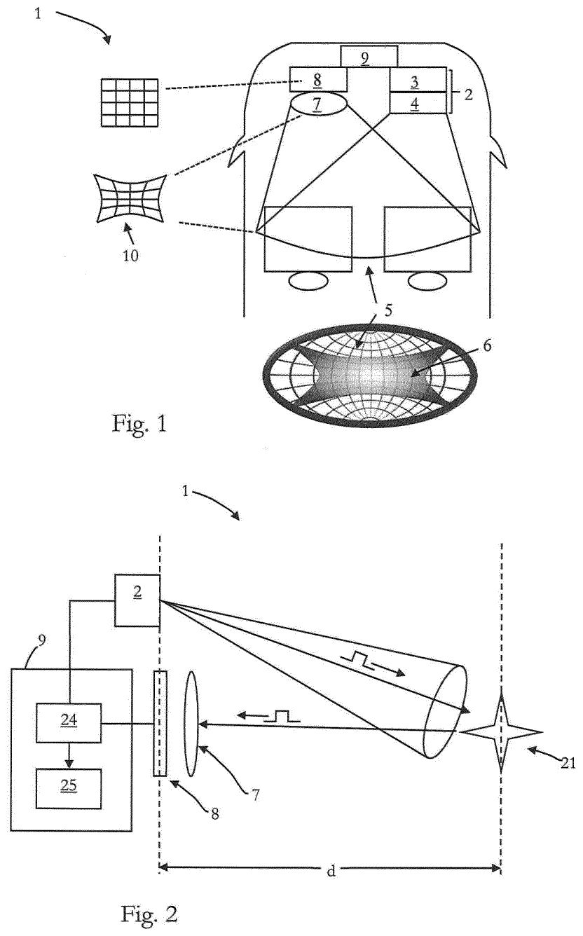

FIG. 2 illustrates a principle functionality of a time-of-flight device 1 as a block diagram.

In the embodiment illustrated in FIG. 2, the ToF device 1, which is used for depth sensing or providing a distance measurement, is configured as an iToF device 1 as in the embodiment of FIG. 1. The ToF device 1 includes the control 9, which is configured to control the ToF functionality, as mentioned-above (and it includes, not shown, corresponding processors, memory and storage as it is generally known to the skilled person).

The ToF device 1 includes the illumination device 2, the optical lens portion 7 and the light detection sensor 8.

The illumination device 2 emits pulsed light to a scene 21, which reflects the light. The reflected light is imaged by the optical lens portion 7 onto the light detection sensor 8.

The light emission time and modulation information is controlled by the control 9 including a time-of-flight measurement unit 24, which also acquires respective information from the light detection sensor 8, when the reflected light from the scene 21 is detected. On the basis of the light waveform represented by the emitted light pulse and a performed demodulation, the time-of-flight measurement unit 24 computes a phase shift of the detected light pulses which have been emitted from the illumination device 2 and reflected by the scene 21 and on the basis thereon it computes a distance d (depth information) between the light detection sensor 8 and the scene 21.

The depth information is fed from the time-of-flight measurement unit 24 to a 3D image reconstruction unit 25 of the control 9, which reconstructs (generates) a 3D image of the scene 21 based on the depth information received from the time-of-flight measurement unit 25.

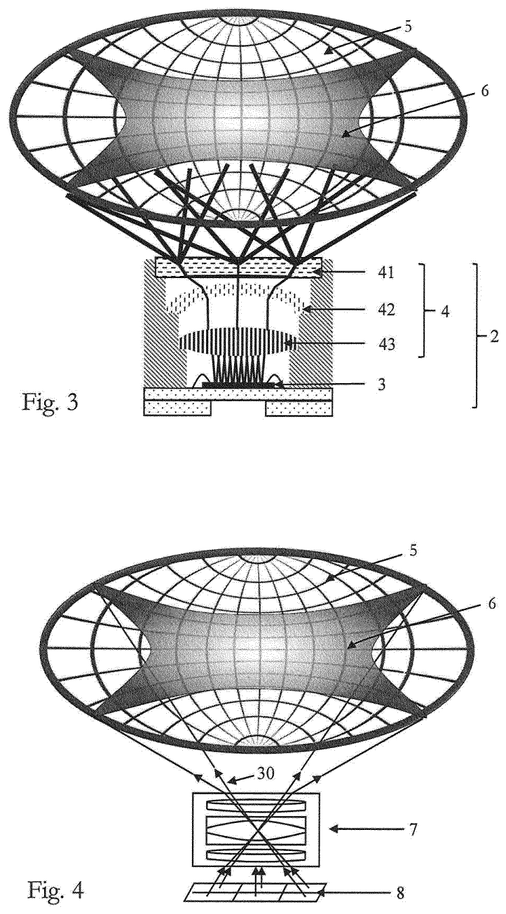

FIG. 3 illustrates an embodiment of an illumination device 2 for a light detection device such as the time-of-flight device 1.

In the embodiment illustrated in FIG. 3, the illumination device 2 includes a light source 3, which is configured according to the embodiments of FIGS. 1 and 2. It further includes a light intensity adapting device 4 which includes a diffractive optical element 41 (illustrated by the horizontally dashed area), a field of illumination shaping lens 42 (illustrated by the vertically dashed area) and a collimating lens 43 (illustrated by the vertically striped area). The DOE includes a micro-structured surface relief (not shown).

The optical elements of the light intensity adapting device are stacked in a mechanical package (illustrated by the sloped striped areas). The light source 3 is mounted on and wired to an electrical package (illustrated by the dotted areas).

Each of the VCSEL elements of the VCSEL array, i.e. the light source 3, emits light towards the collimating lens 43, which forms a light emission profile. The collimating lens 43 is configured to bundle the light emission profile and provide a parallel beam.

Then, the field of illumination shaping lens 42 is configured to adapt the illumination pattern of the light intensity profile 6 on the predetermined virtual target area 5, here a spherical area. The intensity distribution of the light intensity profile 6 on the predetermined virtual target area is adapted by the DOE.

FIG. 4 illustrates a principle of a calculation method of a field of view of an optical lens portion 7 on a predetermined virtual target area 5.

The light detection sensor 8 is configured as in the embodiments of FIGS. 1 and 2, but for illustration purposes only 6 pixels are shown, which of course does not limit the present disclosure to this particular configuration.

A projection vector 30 is emitted (conceptually of course) from each pixel of the light detection sensor 8. The projection vectors 30 are refracted by the optical lens portion 7 (the light path shown in FIG. 4 does not necessarily represent the light path in a real situation, since it is only for illustration purposes) and intersect at a certain angle at an output surface of the optical lens portion 7.

The extension of the projection vectors 30 at the output surface towards the predetermined virtual target area 5, here a spherical area, leads to an intersection with the predetermined virtual target area 5. This intersection gives the image of the light detection sensor 8 as distorted by the optical lens portion 7 and defines the field of view of the optical lens portion 7. This corresponds to the part of the scene, which is effectively detected by the light detection sensor 8.

This further defines the illumination pattern of the light intensity profile, which is adapted by an illumination device 2.

Hence, going backwards, light reflected by a scene, wherein the reflecting objects are present on or in the vicinity of the predetermined virtual target area 5, which is illuminated with the light intensity profile provides at least partially a uniform light intensity on the light detection sensor 8.

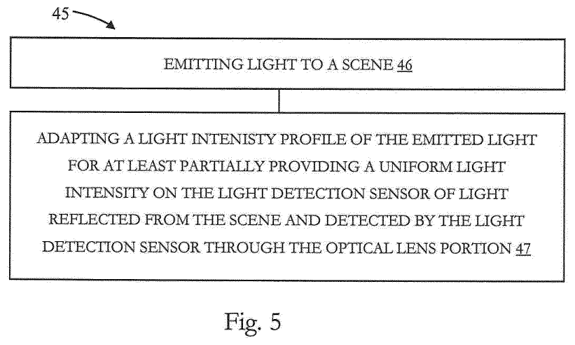

FIG. 5 shows a flowchart of an embodiment of a method for providing light detected by a light detection device 45.

In the following, it is referred to FIG. 1 for illustration of the method 45.

At 46, light is emitted to a scene, as discussed.

At 47, a light intensity profile 6 of the emitted light is adapted for at least partially providing a uniform light intensity on the light detection sensor 8 of light reflected from the scene and detected by the light detection sensor 8 through the optical lens portion 7, as discussed.

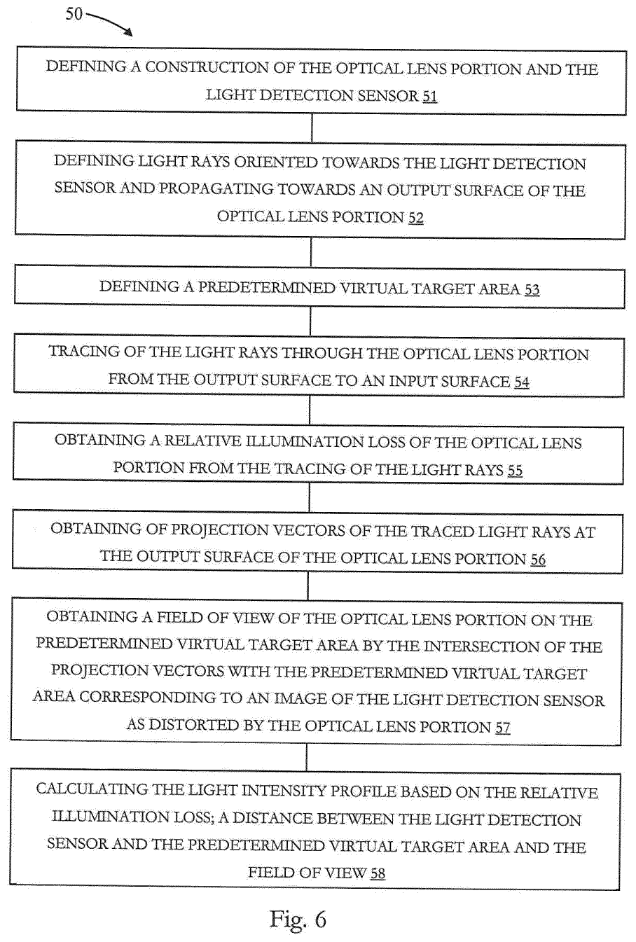

FIG. 6 shows a flowchart of an embodiment of a method for calculating a light intensity profile for light detection device 50.

In the following, it is referred to FIG. 4 for illustration of the method 50.

At 51, a construction of the optical lens portion 7 and the light detection sensor 8 is defined, as discussed.

At 52, light rays oriented towards the light detection sensor 8 and propagating towards an output surface of the optical lens portion 7 are defined, as discussed.

At 53, a predetermined virtual target area 5 is defined, as discussed.

At 54, the light rays are traced through the optical lens portion 7 from the output surface to an input surface, as discussed.

At 55, a relative illumination loss of the optical lens portion 7 is obtained from the tracing of the light rays, as discussed.

At 56, projection vectors 30 of the traced light rays are obtained at the output surface of the optical lens portion 7, as discussed.

At 57, a field of view of the optical lens portion 7 on the predetermined virtual target area 5 is obtained by the intersection of the projection vectors 30 and the predetermined virtual target area 5 corresponding to an image of the light detection sensor 8 as distorted by the optical lens portion 7, as discussed.

At 58, the light intensity profile 6 based on a distance to the predetermined virtual target area, the field of view and the relative illumination loss is calculated, as discussed.

It should be recognized that the embodiments describe methods with an exemplary ordering of method steps. The specific ordering of method steps is, however, given for illustrative purposes only and should not be construed as binding. For example, the ordering of 52 and 53 in the embodiment of FIG. 6 may be exchanged. Also, the ordering of 55 and 56 in the embodiment of FIG. 6 may be exchanged. Other changes of the ordering of method steps may be apparent to the skilled person.

Please note that the division of the control 9 into units 24 to 25 is only made for illustration purposes and that the present disclosure is not limited to any specific division of functions in specific units. For instance, the control 9 could be implemented by a respective programmed processor, field programmable gate array (FPGA) and the like.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An illumination device for a light detection device, the light detection device including a light detection sensor and an optical lens portion, wherein the illumination device includes:
a light source configured to emit light to a scene; and
a light intensity adapting device configured to adapt a light intensity profile of the light emitted by the light source for at least partially providing a uniform light intensity on the light detection sensor of light reflected from the scene and detected by the light detection sensor through the optical lens portion.

(2) The illumination device of (1), wherein the adaption of the light intensity profile is based on a relative illumination loss of the optical lens portion.

(3) The illumination device of (2), wherein the adaption of the light intensity profile is further based on a distance between the light detection sensor and a predetermined virtual target area.

(4) The illumination device of (3), wherein the adaption of the light intensity profile is further based on a shape of the predetermined virtual target area.

(5) The illumination device of (4), wherein the adaption of the light intensity profile is further based on a field of view of the optical lens portion projected onto the predetermined virtual target area.

(6) The illumination device of (4) or (5), wherein the predetermined virtual target area is a curved area.

(7) The illumination device of anyone of (2) to (6), wherein the light intensity adapting device includes a diffractive optical element configured to adapt the light intensity profile based on the relative illumination loss of the optical lens portion.

(8) The illumination device of (7), wherein the light intensity adapting device further includes a field of illumination adapting lens configured to adapt the light intensity profile based on the field of view of the optical lens portion projected onto the predetermined virtual target area.

(9) The illumination device of (8), wherein the light intensity adapting device further includes a collimating lens configured to bundle the light emitted by the light source.

(10) The illumination device of anyone of (7) to (9), wherein the diffractive optical element includes a micro-structured surface relief profile.

(11) The illumination device of anyone of (1) to (10), wherein the light source is controllable by an electric signal.

(12) The illumination device of (11), wherein the light source includes a vertical cavity surface emitting laser

(13) The illumination device of (12), wherein the vertical cavity surface emitting laser emits near infrared light.

(14) A light detection device, including:
a light detection sensor configured to detect light;
an optical lens portion configured to image light reflected from a scene onto the light detection sensor;
a control configured to acquire images from the detected light; and
an illumination device for the light detection device, wherein the illumination device includes:
   a light source configured to emit light to the scene; and
   a light intensity adapting device configured to adapt a light intensity profile of the light emitted by the light source for at least partially providing a uniform light intensity on the light detection sensor of light reflected from the scene and detected by the light detection sensor through the optical lens portion.

(15) The light detection device of (14), wherein the control is further configured to pre-process the acquired images.

(16) The light detection device of (14) or (15), wherein the control is further configured to control the light source by an electric signal.

(17) The light detection device of anyone of (14) to (16), wherein the optical lens portion includes a wide field of view lens.

(18) The light detection device of (17), wherein the wide field of view lens includes a fisheye lens.

(19) The light detection device of anyone of (14) to (18), wherein the light detection sensor includes a plurality of light detection pixel.

(20) A method for providing light detected by a light detection device, the light detection device including a light detection sensor and an optical lens portion, the method including:
emitting light to a scene; and
adapting a light intensity profile of the emitted light for at least partially providing a uniform light intensity on the light detection sensor of light reflected from the scene and detected by the light detection sensor through the optical lens portion.

(21) A method for calculating a light intensity profile for a light detection device including a light detection sensor configured to detect light; an optical lens portion configured to image light reflected from a scene onto the light detection sensor; a control configured to acquire images from the detected light; and an illumination device for the time-of-flight device, wherein the illumination device includes a light source configured to emit light to the scene; and a light intensity adapting device configured to adapt a light intensity profile of the light emitted by the light source for at least partially providing a uniform light intensity on the light detection sensor of light reflected from the scene and detected by the light detection sensor through the optical lens portion;
the method including:
   defining a construction of the optical lens portion and the light detection sensor;
   defining light rays oriented towards the light detection sensor and propagating towards an output surface of the optical lens portion;
   defining a predetermined virtual target area;
   tracing of the light rays through the optical lens portion from the output surface to an input surface;
   obtaining a relative illumination loss of the optical lens portion from the tracing of the light rays;
   obtaining of projection vectors of the traced light rays at the output surface of the optical lens portion;
   obtaining a field of view of the optical lens portion on the predetermined virtual target area by the intersection of the projection vectors with the predetermined virtual target area corresponding to an image of the light detection sensor as distorted by the optical lens portion; and
   calculating the light intensity profile based on the relative illumination loss, a distance between the light detection sensor and the predetermined virtual target area, and the field of view.

(22) A computer program comprising program code causing a computer to perform the method according to (20) or (21), when being carried out on a computer.

(23) A non-transitory computer-readable recording medium that stores therein a computer program product, which, when executed by a processor, causes the method according to according to (20) or (21) to be performed.

1. An illumination device for a light detection device, the light detection device including a light detection sensor and an optical lens portion, wherein the illumination device comprises:
a light source configured to emit light to a scene; and
a light intensity adapting device configured to adapt a light intensity profile of the light emitted by the light source for at least partially providing a uniform light intensity on the light detection sensor of light reflected from the scene and detected by the light detection sensor through the optical lens portion.

2. The illumination device of claim 1, wherein the adaption of the light intensity profile is based on a relative illumination loss of the optical lens portion.

3. The illumination device of claim 2, wherein the adaption of the light intensity profile is further based on a distance between the light detection sensor and a predetermined virtual target area.

4. The illumination device of claim 3, wherein the adaption of the light intensity profile is further based on a shape of the predetermined virtual target area.

5. The illumination device of claim 4, wherein the adaption of the light intensity profile is further based on a field of view of the optical lens portion projected onto the predetermined virtual target area.

6. The illumination device of claim 4, wherein the predetermined virtual target area is a curved area.

7. The illumination device of claim 2, wherein the light intensity adapting device includes a diffractive optical element configured to adapt the light intensity profile based on the relative illumination loss of the optical lens portion.

8. The illumination device of claim 7, wherein the light intensity adapting device further includes a field of illumination adapting lens configured to adapt the light intensity profile based on the field of view of the optical lens portion projected onto the predetermined virtual target area.

9. The illumination device of claim 8, wherein the light intensity adapting device further includes a collimating lens configured to bundle the light emitted by the light source.

10. The illumination device of claim 7, wherein the diffractive optical element includes a microstructured surface relief profile.

11. The illumination device of claim 1, wherein the light source is controllable by an electric signal.

12. The illumination device of claim 11, wherein the light source includes a vertical cavity surface emitting laser.

13. The illumination device of claim 12, wherein the vertical cavity surface emitting laser emits near infrared light.

14. A light detection device, comprising:
a light detection sensor configured to detect light;
an optical lens portion configured to image light reflected from a scene onto the light detection sensor;
a control configured to acquire images from the detected light; and
an illumination device for the light detection device, wherein the illumination device includes:
a light source configured to emit light to the scene; and
a light intensity adapting device configured to adapt a light intensity profile of the light emitted by the light source for at least partially providing a uniform light intensity on the light detection sensor of light reflected from the scene and detected by the light detection sensor through the optical lens portion.

15. The light detection device of claim 14, wherein the control is further configured to pre-process the acquired images.

16. The light detection device of claim 14, wherein the control is further configured to control the light source by an electric signal.

17. The light detection device of claim 14, wherein the optical lens portion includes a wide field of view lens.

18. The light detection device of claim 17, wherein the wide field of view lens includes a fisheye lens.

19. The light detection device of claim 14, wherein the light detection sensor includes a plurality of light detection pixel.

20. A method for providing light detected by a light detection device, the light detection device including a light detection sensor and an optical lens portion, the method comprising:
emitting light to a scene; and
adapting a light intensity profile of the emitted light for at least partially providing a uniform light intensity on the light detection sensor of light reflected from the scene and detected by the light detection sensor through the optical lens portion.
